(19) United States
(12) Patent Application Publication
(10) Pub. No.: US 2019/0056929 A1
(43) Pub. Date: Feb. 21, 2019

(54) DATA TRANSMISSION METHOD AND COMMUNICATION SYSTEM

(71) Applicant: ABILITY ENTERPRISE CO., LTD., New Taipei City (TW)

(72) Inventor: Shiu-Yung LIN, New Taipei City (TW)

(21) Appl. No.: 16/104,201

(22) Filed: Aug. 17, 2018

Related U.S. Application Data
(60) Provisional application No. 62/546,571, filed on Aug. 17, 2017.

(51) Int. Cl. G06F 8/658; G06F 17/30; G06F 9/4401

(52) U.S. Cl. CPC G06F 8/658; G06F 9/4408; G06F 17/30578

(57) ABSTRACT

The present invention discloses a data transmission method, comprising: adopting a first electronic device to obtain a first file from a third electronic device, and the first file having a first data; using at least one of the first electronic device and a second electronic device to compare the first data with a second data of the second electronic device and generate a first result, while the first electronic device and the second electronic device are electrically connected; and determining whether the first result meets a condition, and if yes, replacing the second data of the second electronic device with the first data.

This application claims the benefit of U.S. provisional application Ser. No. 62/546,571, filed Aug. 17, 2017, the subject matter of which is incorporated herein by reference.

### BACKGROUND OF THE INVENTION

### Field of the Invention

The invention relates to a data transmission method and a communication system.

### SUMMARY OF THE INVENTION

The purpose of the present invention is to provide a data transmission method and a communication system, for updating data of one electronic device through another electronic device.

An aspect of the present invention discloses a data transmission method, comprising: adopting a first electronic device to obtain a first file from a third electronic device, and the first file having a first data; using at least one of the first electronic device and a second electronic device to compare the first data with a second data of the second electronic device and generate a first result, while the first electronic device and the second electronic device are electrically connected; and determining whether the first result meets a condition, and if yes, replacing the second data of the second electronic device with the first data.

Another aspect of the present invention discloses a communication system. The communication system comprises a first electronic device, a second electronic device and a third electronic device. The second electronic device includes a second data and electrically connects to the first electronic device. The third electronic device provides a first file having a first data to the first electronic device. The second electronic device receives the first data via the first electronic device and replaces the second data with the first data.

Yet another aspect of the present invention discloses a communication system. The communication system comprises a first electronic device and a second electronic device. The first electronic device includes a first storage module and a first data. The first data is stored in the first storage module. The second electronic device includes a second storage module and a second data. The second data is stored in the second storage module. At least one of the first electronic device and the second electronic device compares the first data and the second data and generates a first result. If the first result meets a condition, the second electronic device replaces the second data with the first data from the first electronic device.

In the embodiments of the present invention, the first electronic device may obtain the first data when obtains the first file from the third electronic device. Moreover, the first electronic device can use the first file to update the second file in the first electronic device. The updated second file includes the first data. The first data includes a newer version of the firmware and/or other updated content corresponding to the second electronic device. With this approach, the first electronic device can obtain the first data without accessing additional server (e.g., the server erected by the manufacturer of the second electronic device). Therefore, the manufacturer of the second electronic device may not need to erect a dedicated server for providing the first data, thereby the cost of erecting the dedicated server can be saved.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a scheme diagram of a communication system according to an embodiment of the present invention.

FIG. 2 shows a scheme diagram of the second electronic device operating a booting procedure according to an embodiment of the present invention.

FIG. 3 shows a flowchart of a data transmission method according to an embodiment of the present invention.

FIG. 4 shows a flowchart of a data transmission method according to another embodiment of the present invention,

FIG. 5 shows a flowchart of an update process according to an embodiment of the present invention.

### DETAILED DESCRIPTION OF THE INVENTION

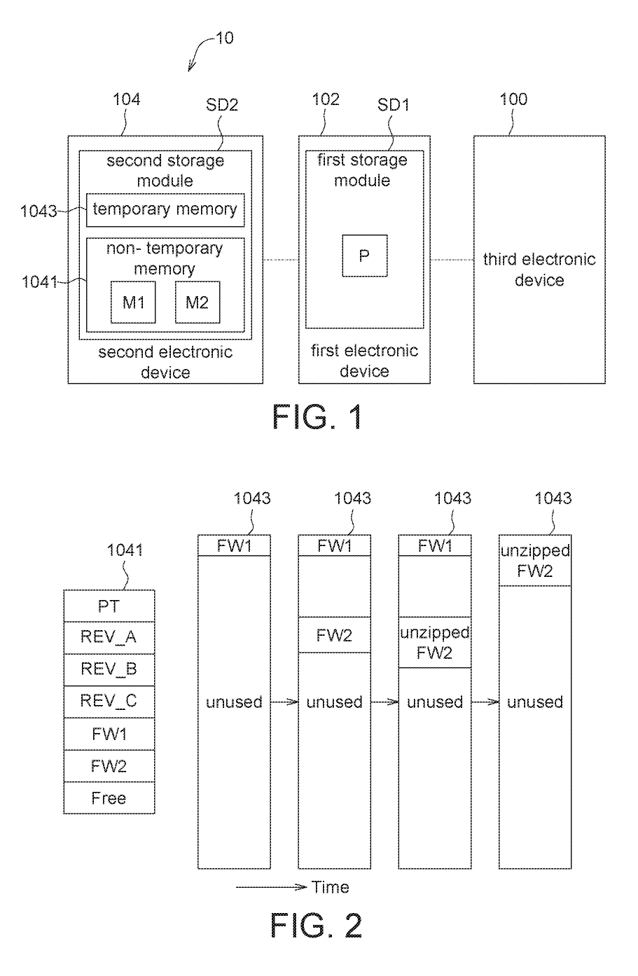

FIG. 1 shows a scheme diagram of a communication system according to an embodiment of the present invention. Referring to FIG. 1, the communication system 10 includes a first electronic device 102 and a second electronic device 104. In an embodiment, the communication system 10 further includes a third electronic device 100. The third electronic device may be a server, which includes, for example, an application store providing applications or online service for the first electronic device 102, such as Google Play, APP store.

The first electronic device 102 may include a first control module (not shown), a first transceiver module (not shown) and a first storage module SD1. The first control module electrically connects to the first transceiver module and the first storage module SD1. The first electronic device 102 may use the first control module to control the first transceiver module and access the first storage module SD1. The first electronic device 102 may connect to the third electronic device 100 by wired connection or wireless connection via the first transceiver module. In this embodiment, the first electronic device 102 may be a mobile phone, a personal computer or a tablet computer. The first storage module SD1 may include a non-temporary computer readable media such as NAND flash memory or NOR flash memory. The non-temporary computer readable media may store a computer readable program P, for example but not limited to APP (Application), including a plurality of computer readable instructions. The computer readable program P may be a second file or include a second file. The second file may include a plurality of computer readable instructions. The first control module may include one or more general purpose processors, one or more specific purpose processing chips or a combination of the above. The first electronic device 102 may use the first control module to perform the computer readable program P (or the second file). In this embodiment, the computer readable program corresponds to the second electronic device 104. The first electronic may use the computer readable program (or the second file) to control the second electronic device 104. For example, the computer readable program may be an application for controlling the second electronic device 104, and an user may operate the computer readable program P to operate or set the second electronic device 104. The first storage module SD1 may be built in the first electronic device 102 internally, or electrically connect to the first control module of the first electronic device 102 through a connection interface (e.g., universal serial bus, USB) externally.

The second electronic device 104 includes a second control module (not shown), a second transceiver module (not shown) and a second storage module SD2. The second control module electrically connects to the second transceiver module and the second storage module SD2. The second electronic device 104 may use the second control module to control the second transceiver module and access the second storage module SD2. The second electronic device 104 electrically connects to the first electronic device 102 by wired connection or wireless connection via the second transceiver module. For example, the second transceiver module may include a connection interface such as USB, and the second transceiver module of the second electronic device 104 may connect to a corresponding interface (e.g., the first transceiver module) of the first electronic device 102 via an USB cable. In this embodiment, the second electronic device 104 is, for example, a camera, a video camera, a monitor, a digital album or the like. The second control module may include one or more general purpose processors, one or more specific purpose processing chips or a combination of the above.

The third electronic device 100 includes a third control module (not shown), a third transceiver module (not shown) and a third storage module (not shown). The third control module electrically connects to the third transceiver module and the third storage module. The third electronic device 100 may be any equipment that can provide server function, for example, be a server providing online service. In some embodiments, the third electronic device 100 may be a mobile phone, a personal computer, a tablet computer or the like.

The “transceiver module” described in the embodiments of the present invention refers to elements or a combination of elements with functions of transmitting and receiving signals. The present invention does not limit the transmission interface of the transceiver modules, and the first transceiver module, the second transceiver module and the third transceiver module may include either the same or different transmission interfaces. The transmission interfaces include, but are not limited to, USB, 3G/4G/5G. Wi-Fi, Bluetooth and near field communication. For example, the first transceiver module of the first electronic device 102 may connect to the third transceiver module of the third electronic device 100 via 3G/4G/5G network, and connect to the second transceiver module of the second electronic device 104 via USB or Bluetooth. In an embodiment, the first electronic device 102 and the second electronic device 104 may use first request signals, first comparison signals and first feedback signals to communicate with each other or exchange data; the first electronic device 102 and the third electronic device 100 may use first notification signals, second request signals, and second comparison signals to communicate with each other or exchange data. The details may be illustrated in following paragraphs.

The second storage module SD2 of the second electronic device 104 may include one or more non-temporary memories 1041 and one or more temporary memories 1043. The non-temporary memory 1041 is non-volatile memory, for example, hard disk, read only memory (ROM), flash memory and so on. The temporary memory 1043 is volatile memory, for example, random access memory (RAM).

The non-temporary memory 1041 of the second electronic device 104 may selectively include a first storage area M1 and a second storage area M2. The first storage area M1 and the second area M2 may belong to the same non-temporary memory or belong to different non-temporary memories respectively. The first storage area M1 may include a first firmware. In an embodiment, the first storage area may be set to read only, and the first firmware may be programmed in the first storage area M1 when the second electronic device 104 is manufactured or leaves the factory. In this example, the firmware of newer version may be stored in the second storage area M2. For example, the second storage area M2 may include a second firmware, and the version of the second firmware may be newer than the version of the first firmware. When the second electronic device 104 receives the second firmware, the second electronic device 104 stores or updates the second firmware into the second storage area M2. In an embodiment, the first firmware and the second firmware may be stored in the second storage module SD2 in a format of firmware image file respectively. After that, when the second electronic device 104 receives a firmware which has a version newer than the version of the second firmware (e.g., a third firmware), the second electronic device 104 may replace the second firmware with the third firmware. That is, the second firmware in the second storage area M2 may be updated to the third firmware. To simplify the description, the following paragraph is illustrated with the second firmware.

In an embodiment, the second electronic device 104 may determine whether the second firmware is valid according to a checking mechanism. If the second firmware is valid, the second electronic device 104 boots up according to the second firmware. In the contrary, if the second firmware is invalid, the second electronic device 104 boots up according to the first firmware. The second electronic device 104 may check whether the second firmware is valid periodically or at a specific time during operation. For example, the second electronic device 104 may determine whether the second firmware in the second storage area M2 is valid during booting according to said checking mechanism.

In an embodiment, the checking mechanism is determining whether the second firmware is valid according to a flag. Specifically, said flag may have a first state and a second state. The first state and the second state may be respectively “0” and “1.” In an embodiment, the first state is “0,” and the second state is “1.” If the flag is the first state, the second electronic device 104 determines that the second firmware is invalid, and if the flag is the second state, the second electronic device 104 determines that the second firmware is valid. Moreover, when the second electronic device 104 is powered on, the second electronic device 104 boots up according to the first firmware if the flag is the first state; and the second electronic device 104 boots up according to the second firmware if the flag is the second state.

In another embodiment, the checking mechanism is to check a cyclic redundancy check (CRC) code or check sum corresponding to the second firmware for determining whether the second firmware is valid. When the CRC code or check sum corresponding to the second firmware is incorrect, the second electronic device 104 determines that the second firmware is invalid and boots up according to the first firmware, and when the CRC code or check sum corresponding to the second firmware is correct, the second electronic device 104 determines that the second firmware is valid and boots up according to the second firmware. In an embodiment, the check sum may be calculated using MD5 Message-Digest Algorithm or Secure Hash Algorithm (SHA).

Similarly, when the second firmware is replaced with the third firmware, the second firmware in the embodiments of the present invention is the third firmware, and the second electronic device 104 may determine whether the third firmware is valid according to the checking mechanism.

FIG. 2 shows a scheme diagram of the second electronic device operating a booting procedure according to an embodiment of the present invention. In this embodiment, the first storage area M1 and the second storage area M2 belong to the same non-temporary memory. Referring to FIG. 2, the non-temporary memory 1041 may store a partition tables PT, basic system data REV_A, updated system data REV_B, checking data REV_C, the first firmware FW1, the second firmware FW2 (or the third firmware) and other data Free. The partition tables PT are configured to record the status of memory partition of the non-temporary memory 1041. The basic system data REV_A may be the data which may not be modified after the second electronic device 104 is manufactured or leaves the factory, for example, the parameters obtained by calibration in the production line, serial number of the device, and the Vendor ID (VID) and Product ID (PID) used for USB transmission. The updated system data REV_B may be the new data which is added after firmware update or system update, and these data, for example, the parameters used for image processing, the icons, the startup screen, and so on, may change with the version of the firmware or the system. The checking data REV_C may be the data which is used for determining whether the second firmware FW2 (or the third firmware) is valid, for example, said flag in above.

In an embodiment, during booting of the second electronic device 104, the second electronic device 104 loads the first firmware FW1 or a part of first firmware FW1 into the temporary memory 1043. Then, the second electronic device 104 performs the checking mechanism for determining whether the second firmware FW2 (or the third firmware) is valid (e.g., determining the state of the flag according to the checking data REV_C), and determining whether to load the second firmware FW2 (or the third firmware). In another embodiment, the checking mechanism, for example, may be to calculate and determine the CRC code or check sum and be implemented in a form of firmware. If the second firmware FW2 (or the third firmware) is valid, the second electronic device 104 may load the second firmware FW2 (or the third firmware) into the temporary memory 1043. In an embodiment, the second electronic device 104 may unzip the second firmware FW2 (or the third firmware), then load the unzipped second firmware FW2 (or the third firmware) into the temporary memory 1043, and boot up according to the second firmware FW2 (or the third firmware). In another case, if the second firmware FW2 (or the third firmware) is invalid, the second electronic device 104 may not load the second firmware FW2 (or the third firmware), but keeps on loading the first firmware FW1, and boots up according to the first firmware FW1. In an embodiment, the second electronic device 104 may use a boot loader to load the first firmware FW1 and/or the second firmware FW2 (or the third firmware).

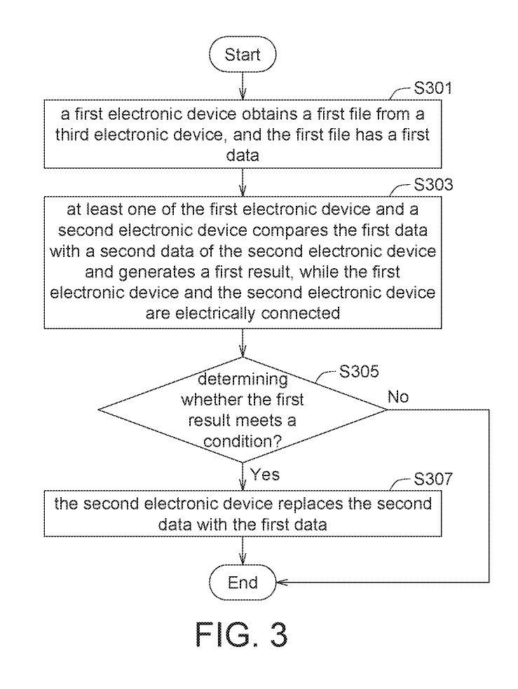

FIG. 3 shows a flowchart of a data transmission method according to an embodiment of the present invention. The data transmission method according to the present invention may be illustrated with FIG. 3 in below. The method may be applied to the communication system 10 described above, and used for updating at least one of the firmware (e.g., the second firmware FW2) and the updated system data REV_B in the second storage area M2. In an embodiment, the method can be implemented by the computer readable program P (or the second file) of the first electronic device 102.

Referring to FIGS. 1˜3, in step S301, a first electronic device 102 obtains a first file from a third electronic device 100, and the first file has a first data. That is, the third electronic device 100 provides the first file having the first data to the first electronic device 102. The first electronic device 102 may store the first file (or the first data) into the first storage module SD1. The first file corresponds to a second file of the first electronic device 102. In an embodiment, for example, the second file is the computer readable program P, and the first file is a newer version of the computer readable program P. In another embodiment, the second file is a part of the computer readable program P, which means that the computer readable program P includes the second file, and the first file is the updated file for the second file. The first electronic device 102 may replace the second file with the first file to update the computer readable program P. The updated computer readable program P includes the first data. The third electronic device 100 may be a server which provides service of application store. The first electronic device 102 may obtain the information that newer version of said computer readable program P has been issued by a notification from the third electronic device 100 or accessing the third electronic device 100 actively, and then obtain the first file from the third electronic device 100. The user of the first electronic device 102 may allow said computer readable program P to automatically download the newer version of said computer readable program P when noticing the newer version of said computer readable program P has been released for obtaining the first file. The first file obtained from the third electronic device 100 includes the first is data.

The first data includes an updated data corresponding to the second electronic device 104. For example, the first data includes a third firmware, and the third firmware is a new version of firmware corresponding to the second electronic device 104 (e.g., a firmware having a version newer than the version of the second firmware FW2). In an embodiment, the first data may include an updated system data (e.g., including newer version of the updated system data REV_B, media file or a combination of the above). In other words, in this embodiment, since the first file has the first data, the first data may be obtained directly from the third electronic device 100 (e,g., application store) with the first file, without accessing other equipment or server (e.g., the server erected by the manufacturer of the electronic device 104) additionally,

For example, the first file provided by the third electronic device 100 has a first file label, used for identifying a first file time corresponding to the first file. For example, the first file label may include at least one of the version, established time, released time or updated time of the first file. The second file in the first electronic device 102 has a second file label, used for identifying a second file time corresponding to the second file. For example, the second file label may include at least one of the version, established time, released time or updated time of the second file. If the first file label is newer than the second file label, it indicates that the first file time is later than the second file time, which means that the version of the first file is newer than the version of the second file. If the first file label is not newer than the second file label, it indicates that the first file time is not later than the second file time, which means that the version of the first file is not newer than the version of the second file.

In an embodiment, when the first electronic device 102 electrically connects to the third electronic device 10 and the third electronic device 100 intends to provide the first file, the third electronic device 100 may send a first notification signal to the first electronic device 102, and suggest the first electronic device 102 to update the second file. In response to the first notification signal, the first electronic device 102 sends a second request signal to the third electronic device 100, and requests the third electronic device 100 to send the first file to the first electronic device 102,

In another embodiment, when the first electronic device 102 electrically connects to the third electronic device 100, the third electronic device 100 may send a second comparison signal to the first electronic device 102, wherein the second comparison signal includes the first file label of the first file. In response to the second comparison signal, the first electronic device 102 compares the first file and the second file according to the first file label and the second file label, and generates a second result. If the first file time is later than the second file time, the first electronic device 102 send the second result to the third electronic device 100, and requests the third electronic device 100 to send the first file. If the first file time is not later than (e.g., earlier than or identical to) the second file time, the first electronic device 102 may store the second result to record corresponding information (e.g., “already the latest version” or “identical version”). However, the first electronic device 102 may also send the second result to the third electronic device 100 to let the third electronic device 100 record the corresponding information (e.g., “already the latest version” or “identical version”).

In yet another embodiment, when the first electronic device 102 electrically connects to the third electronic device 100, the first electronic device 102 may send a second comparison signal to the third electronic device 100, wherein the second comparison signal includes the second file label of the second file. In response to the second comparison signal, the third electronic device 100 compares the first file and the second file according to the first file label and the second file label, and generates a second result. If the first file time is later than the second file time, the third electronic device 100 sends the first file to the first electronic device 102, and selectively sends the second result to the first electronic device 102. If the first file time is not later than (e.g., earlier than or identical to) the second file time, the third electronic device 100 may store the second result to record corresponding information (e.g., “already the latest version” or “identical version”). However, the third electronic device 100 may also send the second result to the first electronic device 102 to let the first electronic device 102 to record the corresponding information (e.g., “already the latest version” or “identical version”).

In the above embodiments, if the first file time is later than the second file time, the second result may include information for identifying that the version of the first file is newer than the version of the second file. If the first file time is not later than the second file time, the second result may include information for identifying that the version of the first file is not newer than the version of the second file. In addition, one of the first electronic device 102 and the third electronic device 100 may perform the operation of comparing the first file with the second file. However, in other embodiments, the first electronic device 102 and the third electronic device 100 can perform the operation of comparing the first file with the second file jointly. For example, the first electronic device 102 compares the first file with the second file, and generates a first sub-result. The third electronic device 100 compares the first file with the second file, and generates a second sub-result, and sends the second sub-result to the first electronic device 102. The first electronic device 102 compares the first sub-result with the second sub-result. If the first sub-result is identical to the second sub-result, the first electronic device 102 takes the first sub-result as the second result. In an embodiment, if the first sub-result is not identical to the second sub-result, the first electronic device 102 takes the first sub-result as the second result. In another embodiment, if the first sub-result is not identical to the second sub-result, the first electronic device 102 and the third electronic device 100 may compare the first file with the second file again according to the approach shown above. In additional, after performing the operation of comparison for a specific number of times, if the first sub-result is still not identical to the second sub-result, the first electronic device 102 and the third electronic device 100 may stop comparing the first file with the second file, and the first electronic device 102 takes the first sub-result as the second result. In another embodiment, the third electronic device 100 may perform the operation of comparing the first sub-result with the second sub-result.

The second result may be represented by different words, symbols or parameters. In an example of parameters, when the version of the first file is newer then the version of the second file, the first electronic device 102 or the third electronic device 100 generates a first parameter as the second result; when the version of the first file is not newer than the version of the second file, the first electronic device 102 or the third electronic device 100 generates a second parameter as the second result. In the example that the first electronic device 102 and the third electronic device 100 make determination jointly, when the first electronic device 102 determines that the version of the first file is newer than the version of the second file, the first electronic device 102 generates the first parameter as the first sub-result, otherwise generates the second parameter as the first sub-result. When the third electronic device 100 determines that the version of the first file is newer than the version of the second file, the third electronic device 100 generates the first parameter as the second sub-result, otherwise generates the second parameter as the second sub-result. For example, the first parameter is “1,” and the second parameter is “0.” In other embodiments, the first parameter is “0,” and the second parameter is “1.”

In step S303, at least one of the first electronic device 102 and a second electronic device 104 compares the first data with a second data of the second electronic device 104 and generates a first result, while the first electronic device 102 and the second electronic device 104 are electrically connected. The second data may be stored in the second storage module SD2. In an embodiment, for example, the second data includes the second firmware FW2, and the first data includes a newer version of the second firmware FW2 (e.g., the third firmware). In another embodiment, the second data further includes system information of the second electronic device 104, and the first data further includes the updated information for said system information.

In an embodiment, at least one of the first electronic device 102 and the second electronic device 104 compares the first data with the second data according to a first label of the first data and a second label of the second data. The first label can be used for identifying a first data time corresponding to the first data, and the second label can be used to identifying a second data time corresponding to the second data. For example, the first label may include at least one of the version, established time, released time and updated time of the first data. The second label may include at least one of the version, established time, released time and updated time of the second data. The first label and the second label can be used for determining whether the version of the first data is newer than the version of the second data. In an embodiment, the first label may include at least one of the version, established time, released time and updated time of the third firmware, and the second label may include at least one of the version, established time, released time and updated time of the second firmware. If the first label is newer than the second label, it indicates that the first data time is later than the second data time, which means that the version of the first data is newer than the version of the second data. If the first label is not newer than the second label, it indicates that the first data time is not later than the second data time, which means that the version of the first data is not newer than the version of the second data.

In an embodiment, when the second electronic device 104 electrically connects to the first electronic device 102, the first electronic device 102 sends a first request signal to the second electronic device 104, and requests the second electronic device 104 to provide the second label. In response to the first request signal, the second electronic device 104 sends a first comparison signal which includes the second label to the first electronic device 102. In response to the first comparison signal, the first electronic device 102 compares the first data with the second data according to the first label and the second label, and generates the first result.

In another embodiment, when the second electronic device 104 electrically connects to the first electronic device 102, the second electronic device 104 sends a first comparison signal which includes the second label to the first electronic device 102, and requests the first electronic device 102 to compare the first label with the second label. In response to the first comparison signal, the first electronic device 102 compares the first data with the second data according to the first label and the second label, and generates the first result.

In yet another embodiment, when the second electronic device 104 electrically connects to the first electronic device 102, the second electronic device 104 sends a first request signal to the first electronic device 102, and requests the first electronic device 102 to provide the first label. In response to the first request signal, the first electronic device 102 sends a first comparison signal which includes the first label to the second electronic device 104. In response to the first comparison signal, the second electronic device 104 compares the first data with the second data according to the first label and the second label, generates the first result, and sends a first feedback signal which includes the first result to the first electronic device 102.

In yet another embodiment, when the second electronic device 104 electrically connects to the first electronic device 102, the first electronic device 102 sends a first comparison signal which includes the first label to the second electronic device 104, and requests the second electronic device 104 to compare the first label with the second label. In response to the first comparison signal, the second electronic device 104 compares the first data with the second data according to the first label and the second label, generates the first result, and sends a first feedback signal which includes the first result to the first electronic device 102.

In the above embodiments, if the first label is newer than the second label, the first result may include information for identifying that the version of the first data is newer than the version of the second data. If the first label is not newer than the second label, the first result may include information for identifying that the version of the first data is not newer than the version of the second data. In addition, one of the first electronic device 102 and the second electronic device 104 may perform the operation of comparing the first data with the second data. However, in other embodiments, the first electronic device 102 and the second electronic device 104 may perform the operation of comparing the first data with the second data jointly. For example, the first electronic device 102 compares the first data with the second data, and generates a first temporary result. The second electronic device 104 compares the first data with the second data, and generates a second temporary result, and sends the second temporary result to the first electronic device 102. The first electronic device 102 compares the first temporary result with the second temporary result. If the first temporary result is identical to the second temporary result, the first electronic device 102 takes the first temporary result as the first result. In an embodiment, if the first temporary result is not identical to the second temporary result, the first electronic device 102 takes the first temporary result as the first result. In another embodiment, if the first temporary result is not identical to the second temporary result, the first electronic device 102 and the second electronic device 104 may compare the first data with the second data again according to the approach shown above. In additional, after performing the operation of comparison for a specific number of times, if the first temporary result is still not identical to the second temporary result, the first electronic device 102 and the second electronic device 104 may stop comparing the first data with the second data, and take the first temporary result as the first result. In another embodiment, the second is electronic device 104 may performed the operation of comparing the first temporary result with the second temporary result.

In step S305, determining whether the first result meets a condition is performed. This step can be performed by the first electronic device 102 or the second electronic device 104.

In step S307, if the first result meets said condition, the second electronic device 104 replaces the second data with the first data. In an embodiment, the first electronic device 102 indicates the second electronic device 104 to perform the operation for replacing the second data with the first data. In another embodiment, the second electronic device 104 performs the operation for replacing the second data with the first data automatically.

For example, if the first data time is later than the second data time, the first result meets the condition. In the contrary, if the first data time is not later than (e.g., earlier than or identical to) the second data time, the first result does not meet the condition. For example, the first label of the first data and the second label of the second data may respectively include at least one of version, established time, released time and updated time. If the released time of the first label is later than the released time of the second label (i.e., the first label is newer than the second label), it is determined that the first data time corresponding to the first data is later than the second data time corresponding to the second data. Therefore, the first result meets the condition, which means the version of the first data is newer than the version of the second data.

In an embodiment, if the first result does not meet the condition, the first electronic device 102 may not send any indication or signal to the second electronic device 104. In another embodiment, if the first result does not meet the condition, the first electronic device 102 may record the first result in the first storage module SD1 of the first electronic device 102 and/or the second storage module SD2 of the second electronic device 104. For example, if the released time of the first label is not later than (e.g., earlier than or identical to) the released time of second label (i.e., the first label is earlier than or identical to the second label), it is determined that the first data time is not later than the second data time. Therefore, the first result does not meet the condition. The first result may be stored into the first electronic device 102 and/or the second electronic device 104 to record corresponding information (e.g., “already the latest version” or “identical version”).

The first result may be represented by different words, symbols or parameters, and the mentioned condition may be represented by words, symbols or parameters corresponding to the first result. In an example of parameters, when the first data time is later then the second data time, the first electronic device 102 or the second electronic device 104 generates a first parameter as the first result; when the first data time is not later then the second data time, the first electronic device 102 or the second electronic device 104 generates a second parameter as the first result. In the example that the first electronic device 102 and the second electronic device 104 make determination jointly, when the first electronic device 102 determines that the first data time is later than the second data time, the first electronic device 102 generates the first parameter as the first temporary result, otherwise generates the second parameter as the first temporary result. When the second electronic device 104 determines that the first data time is later then the second data time, the second electronic device 104 generates the first parameter as the second temporary result, otherwise generates the second parameter as the second temporary result. In an embodiment, said condition may be that the first result is the first parameter. In other words, when the first result is the first parameter, the first result meets the condition; when the first result is the second parameter, the first result does not meet the condition. For example, the first parameter is “1,” and the second parameter is “0.” In other embodiments, the first parameter is “0,” and the second parameter is “1.”

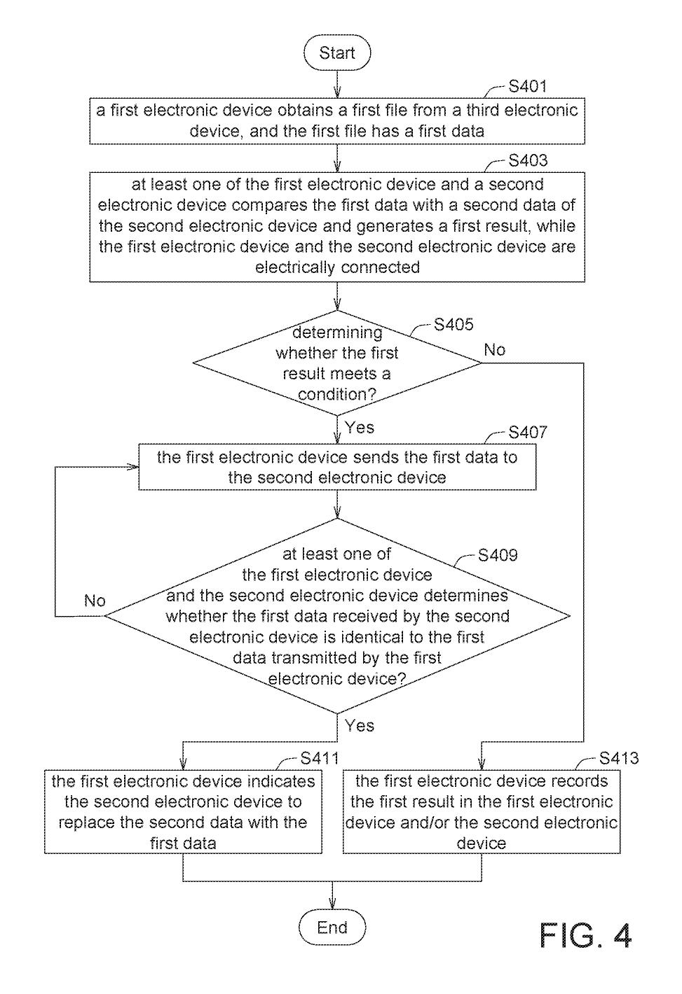

FIG. 4 shows a flowchart of a data transmission method according to another embodiment of the present invention. Steps S401-S405 in FIG. 4 are similar to steps S301-S305 in FIG. 3, and may not be illustrated repeatedly herein. Details of steps S407-S413 may be illustrated below.

Referring to FIGS. 1, 2 and 4, in step S407, if the first result meets the condition, the first electronic device 102 sends the first data to the second electronic device 104. Then, in step S409, at least one of the first electronic device 102 and the second electronic device 104 determines whether the first data received by the second electronic device 104 is identical to the first data transmitted by the first electronic device 102. The first electronic device 102 may indicate the second electronic device 104 to verify the received first data. In an embodiment, the first electronic device 102 and the second electronic device 104 may jointly perform a verification process to determine whether the first data received by the second electronic device 104 is identical to the first data transmitted by the first electronic device 102. For example, the first electronic device 102 may request the second electronic device 104 to calculate and report the CRC code (or check sum) of the received first data. When the CRC code or check sum reported by the second electronic device 104 is identical to the CRC code or check sum calculated according to the transmitted first data by the first electronic device 102, the first electronic device 102 may determine that the first data received by the second electronic device 104 is identical to the first data transmitted by the first electronic device 102, and then the first electronic device 102 may send a notification signal to the second electronic device 104. That is, the first electronic device 102 may notify the second electronic device 104 that the received first data is correct. In another embodiment, the first electronic device 102 may send both the first data and the CRC code (or check sum) of the first data to the second electronic device 104. The second electronic device 104 may calculate the CRC code (or check sum) of the received first data. If the calculated CRC code (or check sum) is identical to the CRC code (or check sum) received from the first electronic device 102, the second electronic device 104 determines that the received first data is identical to the first data transmitted by the first electronic device 102.

If the first data received by the second electronic device 104 is identical to the first data transmitted by the first electronic device 102, in step S411, the first electronic device 102 indicates the second electronic device 104 to replace the second data with the first data. The second electronic device 104 may perform an update process according to the indication of the first electronic device 102, and the update process includes replacing the second data with the first data. In other hand, if the first data received by the second electronic device 104 is not identical to the first data transmitted by the first electronic device 102, step S407 may be performed again, and the first electronic device 102 may re-send the first data. In some embodiments, the first electronic device 102 may provide an user interface for requesting the user to confirm whether to perform the update process or not. After the user confirms to perform the update process, the first electronic device 102 indicates the second electronic device 104 to perform the update process (i.e., to perform step S411). In another embodiment, in step S411, the second electronic device 104 may perform the update process automatically without indication from the first electronic device 102, or the second electronic device 104 may perform the update process after obtaining confirmation from the user by an user interface.

In the operation of replacing the second data with the first data, the second electronic device 104 may replace the second firmware with the third firmware of the first data to update the second firmware to the third firmware. For example, the second electronic device 104 may overwrite the entire second firmware with the third firmware. However, in another embodiment, the second electronic device 104 may overwrite a portion of the second firmware that is different from the third firmware according to the third firmware. In the example that the first data includes data other than the third firmware, the second electronic device 104 may selectively replace the data other than the second firmware of the second data with the data other than the third firmware of the first data, for example, a portion corresponding to the updated system data or media file in the first data.

In a specific embodiment, when step S301 (or S401) is performed, and the second electronic device 104 has electrically connected to the first electronic device 102, the first electronic device 102 may directly performs the subsequent steps after the first electronic device 102 obtains the first file (or first data).

In another specific embodiment, the first electronic device 102 may not perform the subsequent steps of step S301 (or S401) immediately after step S301 (or S401) is done. For example, the first electronic device 102 may perform the operation of step 301 while the second electronic device 104 does not connect to the first electronic device 102 yet. Then, when the second firmware and/or other information of the second electronic device 104 need/needs to be updated, the second electronic device 104 then connects to the first electronic device 102, and the subsequent step of step S301 (or S401) are performed. In other words, it may be continuous or intermittent between step S301 (or S401) and the subsequent steps thereof.

Additionally, in step S413, if the first result does not meet the condition, the first electronic device 102 records the first result in the first electronic device 102 and/or the second electronic device 104. The details of this step may refer to the above description.

In another specific embodiment, in a state that the first electronic device 102 and the second electronic device 104 are electrically connected, the first electronic device 102 may not perform the step of comparing the first data and the second data (e.g., S303 or S403) and the step of determining whether the first result meets the condition (e.g., S305 or S405) after step S301 (or S401) is done, and directly performs the step of replacing the second data with the first data (e.g., S307 or S407-S413).

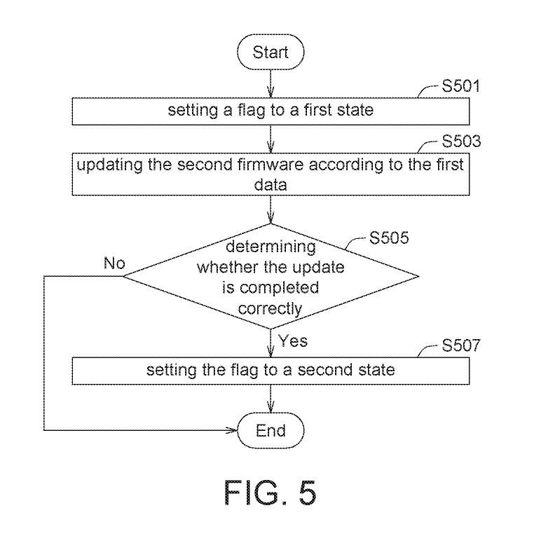

FIG. 5 shows a flowchart of an update process according to an embodiment of the present invention. As described above, in an embodiment, the second electronic device 104 determines whether to boot by the first firmware according to that the flag is the first state or the second state. In such an embodiment, the update process may include a number of steps as shown in FIG. 5. Referring to FIGS. 1, 2 and 5, in step S501, the second electronic device 104 sets a flag to a first state. After the flag is set, in step S503, the second electronic device 104 updates the second firmware according to the first data, for example, the second electronic device 104 replaces the second data with the first data (including replacing the second firmware (e.g., the second firmware FW2) with the third firmware, replacing original system data (e.g., the updated system data REV_B) with the updated information of the first data or a combination of the above). Then, in step S505, the second electronic device 104 determines whether the update is completed correctly. For example, the second electronic device 104 may check whether the CRC code or check sum of the updated second firmware (or the third firmware) is correct. If the CRC code or check sum is correct, the second electronic device 104 determines that the update is completed correctly. After the second electronic device 104 determines that the update is completed correctly, in step S507, the second electronic device 104 sets the flag to a second state. After step S507, the second electronic device 104 may boot up according to the updated second firmware (or the third firmware). With the above steps, if an error (e.g., power off, the first data is corrupted, etc.) occurs during performing the update process and results in that the update process can't be completed correctly, the flag may remain in the first state, without being set to the second state. Since the flag is the first state, therefore the second electronic device 104 may boot up according to the first firmware FW1 in next starting up, thereby the case that the second electronic device 104 cannot boot up due to the second firmware which is not correctly updated (or the incorrect third firmware) can be avoided.

In some embodiments, the second electronic device 104 further includes the checking mechanism of checking the second firmware (or the third firmware), such as calculating whether the CRC code or check sum is correct, to determine whether the second firmware (or the third firmware) is valid. The second electronic device 104 may check whether the second firmware (or the third firmware) is valid according to the above checking mechanism during booting up. In such an embodiment, the second electronic device 104 may boot up according to the first firmware when the second firmware (or the third firmware) is determined invalid, thereby the case that the second electronic device cannot boot up due to an incorrect update can be avoided. The checking mechanism may be implemented in a form of software or hardware. In an embodiment, the checking mechanism may be implemented in a form of firmware, and included in the first firmware.

In the embodiments of the present invention, the first electronic device 102 may obtain the first data when obtains the first file from the third electronic device 100. Moreover, the first electronic device 102 can use the first file to update the second file in the first electronic device 102. The updated second file has the first data. The first data includes a newer version of the firmware and/or other updated content corresponding to the second electronic device 104. With this approach, the first electronic device 102 can obtain the first data without accessing additional server (e.g., the server erected by the manufacturer of the second electronic device 104). Therefore, the manufacturer of the second electronic device 104 may not need to erect a dedicated server for providing the first data, thereby the cost of erecting the dedicated server can be saved.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data transmission method, comprising:
adopting a first electronic device to obtain a first file from a third electronic device, and the first file having a first data;
using at least one of the first electronic device and a second electronic device to compare the first data with a second data of the second electronic device and generate a first result, while the first electronic device and the second electronic device are electrically connected; and
determining whether the first result meets a condition, and if yes, replacing the second data of the second electronic device with the first data.

2. The data transmission method according to claim 1, wherein the step of using the at least one of the first electronic device and the second electronic device to compare the first data with the second data of the second electronic device and generate the first result, while the first electronic device and the second electronic device are electrically connected, comprises:
adopting the first electronic device to receive a second label of the second data from the second electronic device; and
using the first electronic device to compare the first data with the second data according to a first label of the first data and the second label of the second data, and generate the first result.

3. The data transmission method according to claim 1, wherein the step of using the at least one of the first electronic device and the second electronic device to compare the first data with the second data of the second electronic device and generate the first result, while the first electronic device and the second electronic device are electrically connected, comprises:
adopting the second electronic device to receive a first label of the first data from the first electronic device; and
using the second electronic device to compare the first data with the second data according to the first label of the first data and a second label of the second data, generate the first result, and transmit the first result to the first electronic device.

4. The data transmission method according to claim 1, wherein the step of determining whether the first result meets the condition, and if yes, replacing the second data of the second electronic device with the first data, comprises:
adopting the first electronic device to transmit the first data to the second electronic device;
determining whether the first data received by the second electronic device is identical to the first data transmitted by the first electronic device, and if yes, replacing the second data of the second electronic device with the first data; and
determining whether the first data received by the second electronic device is identical to the first data transmitted by the first electronic device, and if no, adopting the first electronic device to send the first data to the second electronic device.

5. The data transmission method according to claim 1, wherein when a first data time corresponding to the first data is later than a second data time corresponding to the second data, the first result meets the condition.

6. The data transmission method according to claim 1, further comprising:
determining whether the first result meets the condition, and if no, using the first electronic device to record the first result.

7. The data transmission method according to claim 1, wherein the second electronic device comprises a first firmware and a second firmware, the first data comprises a third firmware, the second data comprises the second firmware, and the step of replacing the second data of the second electronic device with the first data, comprises:
setting a flag to a first state;
replacing the second firmware with the third firmware; and
setting the flag to a second state after he step of replacing the second
firmware with the third firmware, when the flag is the first state, the second electronic device boots up according to the first firmware, and when the flag is the second state, the second electronic device boots up according to the third firmware.

8. The data transmission method according to claim 1, further comprising:
replacing a second file of the first electronic device with the first file, and the second file corresponding to the second electronic device.

9. A communication system, comprising:
a first electronic device;
a second electronic device, including a second data and electrically connecting to the first electronic device; and
a third electronic device, providing a first file having a first data to the first electronic device, and the second electronic device receiving the first data via the first electronic device and replacing the second data with the first data.

10. The communication system according to claim 9, wherein when the first data received by the second electronic device is identical to the first data transmitted by the first electronic device, the second electronic device replaces the second data with the first data, and when the first data received by the second electronic device is not identical to the first data transmitted by the first electronic device, the first electronic device sends the first data to the second electronic device.

11. The communication system according to claim 9, wherein when the first data received by the second electronic device is identical to the first data transmitted by the first electronic device, the first electronic device indicates the second electronic device to replace the second data with the first data.

12. The communication system according to claim 9, wherein the second electronic device comprises a first firmware and a second firmware, the first data at least comprises a third firmware, the second data comprises the second firmware, and in the operation that the second electronic device replaces the second data with the first data, the second electronic device sets a flag to a first state, replaces the second firmware with the third firmware, and sets the flag to a second state after the operation of replacing the second firmware with the third firmware, when the flag is the first state, the second electronic device boots up according to the first firmware, and when the flag is the second state, the second electronic device boots up according to the third firmware.

13. The communication system according to claim 9, wherein the first electronic device replaces a second file of the first electronic device with the first file, and the second file is corresponding to the second electronic device.

14. A communication system, comprising:
a first electronic device, including a first storage module and a first data in the first storage module; and
a second electronic device, including a second storage module and a second data in the second storage module, and at least one of the first electronic device and the second electronic device comparing the first data and the second data and generating a first result, if the first result meets a condition, the second electronic device replacing the second data with the first data from the first electronic device.

15. The communication system according to claim 14, wherein the first electronic device obtains a second label of the second data from the second electronic device, compares the first data with the second data according to a first label of the first data and the second label of the second data, and generates the first result.

16. The communication system according to claim 14, wherein the second electronic device obtains a first label of the first data from the first electronic device, compares the first data with the second data according to the first label of the first data and a second label of the second data, generates the first result, and sends the first result to the first electronic device.

17. The communication system according to claim 14, wherein when a first data time corresponding to the first data is later than a second data time corresponding to the second data, the first result meets the condition,

18. The communication system according to claim 14, wherein when the first result does not meet the condition, the first electronic device records the first result.

19. The communication system according to claim 14, wherein when the first data received by the second electronic device is identical to the first data transmitted by the first electronic device, the second electronic device replaces the second data with the first data, and when the first data received by the second electronic device is not identical to the first data transmitted by the first electronic device, the first electronic device sends the first data to the second electronic device.

20. The communication system according to claim 14, wherein the second electronic device comprises a first firmware and a second firmware, the first data at least comprises a third firmware, the second data comprises the second firmware, and in the operation that the second electronic device replaces the second data with the first data via the first electronic device, the second electronic device sets a flag to a first state, replaces the second firmware with the third firmware, and sets the flag to a second state after the operation of replacing the second firmware with the third firmware, when the flag is the first state, the second electronic device boots up according to the first firmware, and when the flag is the second state, the second electronic device boots up according to the third firmware.
